(19) United States
(12) Patent Application Publication
(10) Pub. No.: US 2014/0274244 A1
(43) Pub. Date: Sep. 18, 2014

(54) ENHANCING TECHNIQUES AND SYSTEMS FOR LOGICAL GAMES, ACTIVITIES AND PUZZLES

(71) Applicants: Indu M. Anand, Chelmsford, MA (US); Ishan Anand, San Francisco, CA (US)

(72) Inventors: Indu M. Anand, Chelmsford, MA (US); Ishan Anand, San Francisco, CA (US)

(21) Appl. No.: 13/843,844

(22) Filed: Mar. 15, 2013

Related U.S. Application Data
(60) Provisional application No. 61/794,208, filed on Mar. 15, 2013.
(60) Provisional application No. 61/799,975, filed on Mar. 15, 2013.

(51) Int. Cl. A63F 13/00; A63F 9/00

(52) U.S. Cl. CPC A63F 13/005; A63F 9/0098
USPC 463/9

(57) ABSTRACT

The present invention pertains to a class of games and activities of skill and logic, particularly to puzzles based on reason and logic. Disclosed are a method and a system for comparing solutions to the puzzles based on the paths to solution and for completion of the activities based on the order of carrying out the steps of the activity. A number of applications of the method are disclosed for development of further puzzles and activities from the initial puzzle or activity, as well as for other enriching experiences and expressions, particularly the method of providing a priori or real time hints to a participant to solve the puzzle or advance in the activity.

### RELATED APPLICATIONS

This application claims the benefit of U.S. Provisional Application Ser. No. 61/794,208 filed on Mar. 15, 2013, and U.S. Provisional Application Ser. No. 61/799,975 filed on Mar. 15, 2013, the contents of both of which are incorporated by reference herein.

### FIELD OF THE INVENTION

The present disclosure pertains to the field of games and activities of skill and logic, including in particular, logic puzzles.

### BACKGROUND

Logic games, games of skill and strategy, puzzles and similar activities have been used by many cultures for millennia for social and educational purposes, and for entertainment. Examples include the games of chess, checkers, parchisee, yahtzee, battleship, chutes and ladders, or tic-tac-toe, and any other games and activities are in the class envisioned for application of the methods and system disclosed by the present invention. Certain variations of physical activities and team sports may also belong in the intended class. For example, variations of physical activities and team sports meeting the criteria described below may be included in the intended class.

The games and activities in the intended class may be collaborative or competitive, and are characterized by subordinate activities, or steps, wherein an actor or player may proceed to a “next step” or one of the several possible “next steps,” and make the decision based on knowledge of the activity, states of the activity up to the moment of taking the step, general knowledge of other players and the milieu, the player's skill and logical “reasonableness” of the next step or steps, and other such factors. The factor of skill and logical reasonableness distinguishes this class of problems from games and activities of pure chance, although the element of chance may be included as an additional decision factor for the intended class of activities.

Games and puzzles involving skill and logic are an intended sub-class. Crossword, word scrambles and numeric puzzles of various types are a category of particular interest. Many such activities are highly popular, and routinely published on pages of newspapers, in books and other media, including the Internet.

Newspapers across the world have traditionally published various puzzles on their pages. Until recently, such puzzles were generally word-based, such as crosswords and word scrambles. However, in 2004, the British newspaper The Times, published a number puzzle called, “Sudoku.” The puzzle quickly became incredibly popular with their readers, and newspapers across the Britain began publishing it. Sudoku is now featured in newspapers and magazines all across the world, and has a whole slew of books devoted to it. Variations of Sudoku and other puzzles inspired by it are gaining popularity as well.

The popularity of Sudoku led to the development of television shows based on the idea of getting the contestants to solve the puzzle live. Viewers at home were also encouraged to compete. In addition, a “World Sudoku Championship” has been held for more than five years to determine the best Sudoku player in the world.

Sudoku is the best known example of the class of logic puzzles to which the method of this invention would apply. However the method is applicable to a much wider class of logic puzzles.

Generally in this class of puzzles or problems, the player or players are given a structure containing a number of cells, or spaces; a collection of characters that are often alphanumeric and asked to fill the cells with the characters according to a set of rules. Some cells may already be filled with the characters by the poser at the start of the puzzle. In the cases where the characters are numerical, the rules may be, but are not necessarily, mathematically based. Similarly, in other cases the characters may have semantic import, but it is not necessarily required by the rules.

The Sudoku puzzle, in the most common version of the puzzle, consists of a grid of 9 blocks of 81 cells, each block consisting of 9 neighboring cells (squares) arranged in a smaller 3×3 grid. Most of the cells are blank at the outset, but several contain numbers. The goal of the puzzle for this typical case is to fill in the blank squares or cells with numbers from 1 to 9 so none of the numbers repeats in any one row or column, or within the 3×3 block containing the cell.

As noted above, Sudoku has given rise to a wide variety of new puzzles. These variations of Sudoku include using different sets of characters, such as letters instead of numbers, using grids of different sizes which utilize numbers from 1 to 4 and up, or using a different layout for the spaces, such as a 16×16 grid instead of 9×9 or an irregular grid.

Among the many interesting changes is the implementation of a new set of rules. For example, in another popular puzzle “Kenken” in addition to the requiring that the numbers filled-in in the columns and rows do not repeat, the numbers in each box (whose length and width are not fixed) are required to produce a result according to the indicated mathematical operation, both of which are typically indicated within the box.

A variation that is a kind of progeny of both Sudoku and Kenken, has the usual 81 grid board and requires that no numbers between 1-9 repeat in any row or column. In addition it has an “overlay” of Kenken-like boxes with the requirement that in each such box the numbers be correct according to a mathematical relation or operation.

These variations are a special class of puzzles are amenable to, and contemplated within, the method of this invention, even though the method is described in detail herein for the typical 81-grid Sudoku.

Despite the myriad of differences, this class of logic puzzles can be characterized as involving activities with a specified and specific set of characters, spaces, and rules, including the rules for filling in the spaces with one or more members of the set of characters. The methods of this invention particularly apply to this class of problems.

### SUMMARY

The present invention provides a way to not only solve the above class of problems, but also a method to compare two or more solutions of a puzzle, or like activity, by comparing the “efficiency” of two or more solutions, where for example, efficiency of a solution is based on the “path” to the solution and may be defined in terms of the number of steps taken by the solution to correctly fill the required spaces vis-à-vis the total number of spaces required to be filled. One reasonable way to define the numerical value of efficiency of the solution may be based on a calculation of how readily from a start the spaces get filled, which may depend on the point at which in the sequence a particular space is filled in.

The present invention adds to this art by disclosing a novel method of computing the “efficiency” of a particular solution of the problem, and of thereby analyzing the problem as to the efficiency.

The disclosed method of computing efficiency of a solution has additional utility, since it may be used further to reveal the inherent structure of the puzzle or activity.

Many further applications are contemplated by utilizing the core method presented herein. For example, the method can be used: to determine the efficiency of two or more players in solving the puzzle; to provide either a priori or dynamic hints to aid a player in attempting completion of the puzzle or activity; to run internet-based collaboration or competition to solve puzzles or carry out similar logic based activities. Other applications within contemplation are: to provide creative expression of the puzzle solutions; to display the solution or solutions for teaching or entertainment of viewers or spectators, including the viewers or spectators of television or live audiences; publication of games, activities and puzzles in various forms of media suitable for mass distribution, such as film, video, CD, DVD and other similar media now in existence or available in the future.

The present invention provides a method and system to solve or complete a class of logic, skill or reason based activities, such as puzzles, games or activities. It provides also the ways to compare two or more instances of completion of an activity and rank them in order of preference, which may then be used, collaboratively or competitively, to find the solution to the problem or to complete the activity.

Further disclosure herein envisions and provides the method for novel, creative expression of the solution or completion of an activity. Some forms of creative expression of an activity or problem may, in turn, serve as springboard to build other puzzles, games or activities, for either collaborative or competitive participation.

The method works by considering not only the execution of each step of the activity or the problem, but also the exact sequence of steps in a solution or completion of the activity.

It is known that while many logic puzzles and activities may only have one, unique solution, there are numerous paths to arrive at the end result. Not only may the players take disparate approaches to solving the puzzle, for example, they may also execute the steps of the activity in disparate sequences. An example of disparate approaches, for instance, is where one player may solve a Sudoku puzzle by a reasoned approach, calculating the placement of each number in a cell, at the opposite end of the spectrum is a person who may simply use trial and error at each step. Despite this difference in approach, however, it is conceivable that the two players may place the correct numbers in the same order or sequence of cells.

The execution of steps towards the solution is disparate, on the other hand, where the cells of the puzzle are filled in different sequential order, whether by different players or by the same player.

Although for a puzzle like Sudoku, disparate approaches or sequential orders of executing the steps will eventually reach the same conclusion, demonstrable differences between them remain. For example, one approach or sequential order may be more “efficient” than the other in arriving at the solution.

When applied in case of activities other than logic puzzles—the method of this invention assumes that activities are carried out step-by-step according to the instructions which control (allow or disallow) how a step in the process is to follow another step. It is also assumed that these activities have a start and a finish, and that from the starting state an activity may lead to finish through a sequence of permissible steps.

In the case of a game of chess, for instance, “a pawn can only move forward to a cell on the board one step removed diagonally” may be an instruction for a step for moving a pawn-piece, and the other instructions for all the game pieces may be provided. The start of the game could be the usual formation of the black and white pieces at opposite edges of the board, and the finish when only one king remains on the board or a stalemate.

Two identical finishes may, however, be arrived at through two distinct sequences of steps, and one sequence may be designated as “preferable” over the other in a game, in part on the basis of its exact sequence of steps.

Similar considerations will apply for other games and activities, including some games of chance, when it is feasible to enumerate all possibilities for a succeeding step from a preceding step—thus excluding those games or activities where there may be an infinite number of steps in a sequence or where there may be an infinite number of possibilities of succession from a step.

For logic puzzles, in particular, typically the possibilities for a succeeding step are fewer and the sequences of steps to conclusion are shorter than in a game of chess. Therefore, the methods disclosed herein may be utilized in exciting new ways: to solve the puzzles and discriminate between different solutions, and in turn, to methodically generate new puzzles, among others.

Methods in accordance with embodiments of the present invention rely on the insight that it is possible to quantify “efficiency” of the approach or sequential order of execution of the puzzle, and discloses a method to objectively determine the efficiency of a particular solution to a logic puzzle, game or activity.

By quantifying the “efficiency” of a path to solution, it becomes possible to compare two different approaches or two different paths to solution as easily as comparing two numbers. The comparison between solutions obtained by different approaches or paths makes possible the methods to create further, novel enrichment and competitive activities based on known or new logic puzzles, games and activities.

It is possible in this context to speak of “optimal” efficiency of solution, which may be defined as an attribute of the puzzle which cannot be surpassed by any path (sequence of steps) leading to the solution to the puzzle/activity. But even when optimal efficiency is either not determined, or determinable, it may be reasonable to speak comparatively of efficiency of one actual (path to) solution over another actual (path to) solution: A solution may be regarded as comparatively more efficient over another if it has a better measure of efficiency (defined in terms of specified criteria, e.g., higher or lower numerical value associated with the paths) than the other. It is also possible to compare two paths to solution based on the overall smaller or larger number of steps. The method of this invention gives examples of definitions of measures of efficiency to address these and similar considerations.

These comparisons between solutions make possible methods to create further, novel enrichment and competitive activities based on known or new logic puzzles, games, and activities.

These concepts are further elaborated below.

Disclosed also is an important application of the method of the present invention to the creation of new games, activities and puzzles starting from known games, activities and puzzles.

### BRIEF DESCRIPTION OF THE DRAWINGS

FIG. 1. is an example of a Sudoku puzzle;

FIG. 2. is an example of a solution of the Sudoku puzzle shown in FIG. 1, using the method in accordance with some embodiments;

FIG. 3. is another example of a Sudoku puzzle;

FIG. 4. is an example of a solution of the Sudoku puzzle shown in FIG. 3, using the method in accordance with some embodiments;

FIG. 5 is a flowchart of a method of ranking sequences of steps of a performance of an activity, in accordance with some embodiments;

FIG. 6 is a diagram illustrating an exemplary computer system on which some embodiments of the invention may be employed;

FIG. 7 is a variation of a method in accordance with some embodiments of the invention, wherein the method is applied to a crossword puzzle from Action Unlimited, a Massachusetts local advertiser publication;

FIG. 8 is a variation of a method in accordance with some embodiments of the invention, wherein the method is applied to an example of the number puzzle “Numbrix” published in the Parade magazine; and

FIG. 9 visually depicts the partial structure of the solution of FIG. 2 where the letters A, B and C correspond to different graphic patterns. For legibility this depiction shows only the squiggly graphic filling cells with labels C. Other cells can similarly be filled with colors, patterns or animation graphics etc.

### DETAILED DESCRIPTION

In some embodiments, the method described herein comprises the following acts: (1) providing an algorithm or mechanism to track the sequence in which the steps of the activity are carried out, typically towards the goal of completing the activity; (2) associating with each step of the activity a quantity, for example a real number, which takes into account the point in the sequence at which the step is carried out; (3) combining the quantities associated with all the steps in the sequence into a measure (taking into account the intended rewards and penalties) depending on the points in the sequence at which the steps are carried out; (4) comparing two or more sequences of steps based on their respective measures obtained in the combining step; and (5) ranking the two or more sequences by the order induced by the comparison of their respective measures.

It should be appreciated that the activity may be any suitable activity that may be performed in steps following different paths. A quantity associated with a step of an activity may be any suitable numerical value, as embodiments of the invention are not limited in this respect. Furthermore, the quantities associated with all the steps in the sequence in which the steps of the activity are carried out may be combined in any suitable manner.

In some embodiments, a result of the ranking of the sequences may be presented on a suitable tangible medium. The tangible medium may comprise, for example, a printed publication, a game board, a computing device, a television set, a tablet, a mobile device (e.g., a mobile phone, a smart phone, a PDA), and any other suitable medium. The result of the ranking may be communicated, via a computerized network, the Internet, or in any other way, to a suitable device or other entity that may then present the ranking.

In some embodiments, the described techniques may be utilized for playing Sudoku and ranking performance of the players. In the example of Sudoku, for instance, observing that a complete solution to the puzzle is a completed path (sequence) of the solution activity, the method outlined above may be understood as follows: (1) maintaining record of the order in which each of the cells are filled by digits 1-9, for example, by associating the “stage” at which an empty cell is filled with one of the letters A, B, C etc.; (2) associating numerical values with each of the letters A, B, C etc. (3) computing a weighted average for the solution, as executed (i.e., the order of filling the cells) as the measure of the specific path (to solution) by using the numbers of cells that carry each of the labels A, B, C etc. and the associated numerical values; (4) comparing two or more solutions (paths) by their respective, computed measures, and (5) ranking the solutions according to their computed measures.

Such a scheme for the puzzle uses comparison between the numerical measures (possibly, weighted averages) for comparing two solutions to the puzzle reached by filling the cells in distinct sequential order. The solution with the smaller weighted average may, for instance, be regarded as more efficient if the labels A, B, C, . . . are associated with numerical values 1, 2, 3, . . . , in increasing order.

This scheme uses the natural order of the set of labels A, B, C, etc. One possible, meaningful way to use these labels is as follows: use the label A for all the cells that may be filled with a number from 1 to 9 based on the rules of the puzzle directly as a result of any numbers provided in any cells at the outset; use the label B for any cell that is filled with the information from at least one filled-in cell carrying the label A, but not from any cell with a “higher” label, B, C, etc.; use the label C for any cell that is filled with the information from at least one filled-in cell with the label B but not from any cell with a label higher than B; and so on.

Utilizing the natural order of alphabetical labels, this process implies that a cell with label A will be filled before another with label B or higher, one with label B before another with label C or higher; and so on. Two cells with the same label are filled independently of each other and the order between them of filling them is unimportant.

The “higher” the label for the cell in this scheme, the harder or longer the work required to fill the cell, and conversely, the lower the label, the faster and easier it is to fill it—thus the procedure has built in penalties for steps carried out later in the sequence, as it drags out to the end of the activity, and rewards steps carried out earlier in the process.

The weighted average depends on the number of cells with each label and is normalized with respect to the total number of empty cells in the puzzle. A large proportion of cells labeled with the beginning letter of the alphabet would generally indicate an “easier” problem compared to one with a higher proportion of ending letters of the alphabet.

In this way, the process provides an intrinsic method, independent of clocked time, to compare two solutions: a solution of a puzzle with the preferable measure may be regarded as more desirable. In a direct competition of several solutions, the winning solution may have the “best,” most preferred measure, for example, the greatest or smallest in value depending on how “measure” is defined quantitatively.

Up until now, time has been the traditional measure of comparing two or more solutions and for rating the players or their solutions in the competitions. The World Sudoku Championships, for example, use timed rounds to determine the champion. This simple comparative measure is rooted in the simple assumption that if a player solves a puzzle faster, then the player would have a more efficient solution, and he or she deserves to win as in an athletic race. This may not always be the case, however.

A person simply guessing the numbers could, through sheer luck, correctly fill in all the spaces before even an advanced player. Furthermore, a time measurement can be affected by many outside factors that do not reflect a player's skill in solving the puzzle, such as the speed at which he or she writes or enters the characters in the cells, or even the familiarity of one player with the medium of noting or recording the solution.

The time criterion simply does not capture the essence of logical superiority of one solution over another. What is needed in such a competition is a method that allows a comparison of the logical sophistication with which the two players solve the problem. This measure may additionally be combined with the speed or the time taken to arrive at the solution to determine the true champion.

The goal of such a competition may be a precise evaluation of one player's logical prowess over another's, and the methods described herein can allow better evaluation of the players' logical approach to solving the problem or the elegance of their solutions, which may be used in conjunction with a time measurement or other criteria.

Some embodiments described herein provide a method, and the system to implement it, for such logical comparison of the two solutions arrived at by two distinct paths of Sudoku; and, in the case of two activities other than puzzles, the embodiments provide a method to compare and determine the winner between two distinct paths or sequential orders of carrying out the steps.

### Applications of the Method

Several interesting embodiments are within contemplation of the invention.

### Variations of a Basic Puzzle

One possible embodiment of the invention could allow multiple players to compete against each other. The path that each player takes in reaching the solution would be used by the method to generate an efficiency score for each player. The player with the best score would win.

In a variation on this embodiment, a single player could calculate his or her score and compare it to the best possible score for a particular puzzle. This could give a player an insight into how to improve his or her solving strategy. It would also allow for multiple attempts at the same puzzle to try and achieve a better efficiency score.

In another possible embodiment, the claimed method is used to develop a system for providing a player with hints for solving the puzzle. Often when solving these puzzles, a player gets stuck, unable to figure out the path forward. Currently, there are only two options available to the player: look at the full solution, if one is available, and fill the sticky cell; or, to give up in desperation. The first option has an element of defeat which takes from the pleasure of solving the puzzle; the second option is utter defeat, and worse.

### Activities Involving Chance

As indicated above, the methods of this disclosure may be used for certain classes of games and activities in addition to an inherent element of chance. For instance, live or remote audience of a Sudoku puzzle solution or competition may place their bets on: the winning player or players; the shortest solution; the best estimate for difficulty level; the number of cells to be labeled A, B, C, etc.; the first row, column or box to be filled and its average measure based on the labels. Many other variations of this use can be created similar to these examples by using the method of labeling the paths to solution.

### Novel Ways to Aid the Player

One application of the present invention is a method of providing hints for solving a Sudoku puzzle or a similar problem. For many such problems, the hints tend to be one-off's, dependent on the real-time state of the puzzle board in process. Therefore, they are limited at best, typically not available for such groups of problems unless the problems are presented in an electronic medium.

Thus, for example, if one tries to solve a puzzle online on the Internet and requests a hint at a particular stage of a Sudoku problem, some of the currently available systems may present a form of hint by marking the next cell where the player may fill in a character based on the cells which the player has already filled in. But, this method of dynamically providing hints at the run time is ad hoc at best, and is not available a priori, for example if the puzzle is printed, say in a book or in a newspaper, where the only hint may be the full solution if available.

On the other hand, embodiments of the present invention can be used to generate a priori hints for each puzzle which can then be used by a player who needs the hints to solve the puzzle, but wants the pleasure of solving the puzzle without consulting the entire solution. These hints can be published in static media, such as books and newspapers. Systematic dynamic hints may be available for electronic or real-time solution activity as well.

The present invention would allow for a subtle way to provide assistance. If a player gets stuck, the method could be used to display all of the spaces which are one step away from the spaces that have been filled in. For example, at the beginning of a puzzle several of the spaces are already filled in. If a player requested a hint at that point, the method could highlight all the spaces which can be determined based only on the given numbers.

In a variation of this embodiment, the spaces of the puzzle could be marked from the outset, as hints, to show at what stage of the progress of the solution, the player might expect to fill each space. For example, by color differentiation: spaces that can be filled at a given stage could be red, while the spaces that can be filled at a different stage could be blue, and so on. This embodiment could be useful for novice players to learn how to play, or for more experienced players attempting to become more proficient.

In another variation of this embodiment, the puzzle would be presented on one page or screen, the puzzle with the hints if desired on another page or screen, and finally the whole solution on yet another page or screen. For a player who is stuck at an interim point of the solution, it might be enough to look at the color-coded hints to focus attention to the way forward—this approach gives the player a path forward while maintaining the challenge, enjoyment or entertainment value of the puzzle activity.

### Non-Visual Ways to Aid the Player

The highlighted spaces in the potential embodiments need not be limited to color-coding or even visual hints. In an appropriate medium, one could use as hints auditory sounds, animation, or video. This would allow for hints that still do not reveal too much of the solution to detract from the pleasure of working out the puzzle. For example, if a player was stuck at a particular point, he or she could select an empty (blank) space. The claimed method would determine at which step the space could be filled, and then play a sound distinctively associated with that step level, distinguishing each number by a distinct sound, somewhat akin to the telephone set's sound or pitch associated with the dialing of numbers.

Additionally, similar to the color coding of visual hints, the auditory sound hints can be determined a priori and communicated to a player when he clicks on a particular cell at any point in the process of solving the puzzle, including the start.

### Use in Education

The present invention uses an intuitive and engaging manner of communicating the logical connections between steps of solving a puzzle or game, with rule discernment and reinforcement built into the game. Therefore, the paths to solution as demonstrated by the methods of this invention can be valuable in the study, teaching and communication of logical analysis and argument.

### Use in Data Security

Using a puzzle as the basis of security key, the methods of this invention can provide an additional dimension of randomization represented by the sequence in which the steps to solution are carried out.

### Auditory Retraining and Uses in Psychological or Therapeutic Setting

A kind of auditory coding of the game board based on auditory hints mentioned above can find utility for training of auditory discrimination, testing or rehabilitation.

### Artistic Expression

The claimed method can also be utilized to provide creative insights into the structure of an individual puzzle itself. When the claimed method divides the spaces to be filled at different stages in the process, it can discriminate between them by layers, grouped relative to the points at which those different spaces may be filled in. Alternatively, it may be possible to group certain spaces into a sequence or “path,” connected by the logical connections which allow the player to fill in the spaces, related in a chain or tree structure.

Such a structure created through the claimed method has many potential uses. A visual depiction of the structure could allow for simple side-by-side comparison of two separate puzzles, or be combined to create an overlay. More creatively, a person could use the visual representation of the structure as the basis for a painting or other work of art.

The visual representation of a suitable puzzle could also be used as the basis of a choreographed dance performance, creatively coordinating its steps to the paths or stages of an individual puzzle.

Another creative application for the structure of a puzzle is as a basis for music. Music, though created through artistic expression, has a great deal of structure. For example, the key a piece is written in, its time signature, or the various chords in a song.

The structure of a puzzle could be used as yet another basis for structure, which could produce or compose musical pieces unique to each individual puzzle. The piece for a typical Sudoku puzzle would depend on creative interpretation of the dimensions corresponding to the numbers, labels and relative positioning of the cells filled with both, for example.

One such use would be similar to Arnold Schoenberg's twelve-tone technique, developed in the early 20^{th} century. Schoenberg's technique called for each of the twelve notes on the chromatic scale to be played equally, without one repeating more than any other. This would prevent the music from being in any particular key. This technique has some innate similarities to a Sudoku puzzle, particularly in its lack of repeats within given groups of cells.

Many or all of these possible uses of the described techniques may be combined into a television program which features all the aspects described above. Competitors could be challenged to complete puzzles, and their solutions would be judged for efficiency. During, between or at the end of these competition rounds, composers and dancers could be challenged to create unique songs and dances based on the individual puzzle. Judges could rate the participants on criteria, such as, the relative efficiency of the solutions, in addition to or on how closely they followed the structure of the puzzle, as well as on its aesthetic values.

As discussed above, the described techniques may be employed in multiple applications. An example of using the techniques with association with a game of Sudoku is described below. The process for other puzzles, games or activities may be described in an analogous manner by appropriately defining the start and finish, and by providing instructions for proceeding from one step of the activity to the next step (or any of the next steps) and by defining the stages, or similarity of stages, of carrying out the activity suitably.

For the case of typical Sudoku, the method may proceed, for example, as follows: (1) maintaining record of the order in which the cells are filled by digits 1-9, by linking the stage at which each cell is filled with the letters A, B, C etc. to represent the stages and the order of filling the empty cells; (2) associating numerical values with each of the letters A, B, C etc. (3) finding a weighted average for the solution, as executed in the exact order of filling the cells, which is the measure of the specific path taken to solution from the numbers of cells that carry each of the labels A, B, C etc. and their associated numerical values; (4) comparing two or more solutions (paths) by their respective measures, and (5) ranking the solutions in order according to their respective measures.

Such a scheme can provide discrimination between two solutions of Sudoku that may be quite similar looking, but differ in preference or desirability by tying their order to the order between real numbers.

In another straightforward application, a scheme based on the method of the present invention may also provide a more precise measure of the difficulty level of a problem, unlike rating the ease or difficulty level by the number of “stars” or similar icons currently in vogue. For example, if the expert Sudoku players can come up with a best solution with a measure of efficiency of 6.9 (assuming that the difficulty level rises as the measure of efficiency increases) then it might be safe to estimate the difficulty level as 7, by estimating a ceiling for the measure.

The explanation of the method is continued in greater detail below for the specific example of Sudoku.

A Linking Step is defined as the step (possibly a subordinate step within the step of filling the cell with the number) of linking a character from the set of Roman alphabet characters A, B, C, . . . with the placement of a number 1-9 in a cell. This set of characters may be augmented by another set of characters, e.g., Cyrillic, if it becomes necessary to go beyond the 26 Roman characters. Or, the set of Roman alphabet may be replaced by another set containing a defined order or sequence.

The letter A is linked with the filling of all cells for which it is necessary to only use the cells filled in and provided at the start of the puzzle. For a cell which can be filled with the correct number but for which it is necessary to use at least one cell filled in at stage A or earlier, link the character B. For a cell for which it is necessary to use at least one cell filled in at stage B or earlier to determine the correct number, link the character C. And so on.

The phrase “necessary to use” in the case of Sudoku means the following: If a cell can only be filled with one number because the placement of any other digit will be inconsistent with at least one rule of Sudoku or at least one other cell filled in at the start, then it is linked with the A. Similarly, if a cell can only be filled with a number because placing any other number in the cell will conflict with a rule or another cell that is linked with the character A, then this cell is filled with the unique number and linked with the label B. And so on.

If a cell can only be filled with the digit 1 because the placement of any other digit will be inconsistent with at least one rule of Sudoku or at least one other cell filled in at the start, then it is linked with the A. Similarly, if a cell can only be filled with the digit 3 because placing any other digit in the cell will conflict with a rule or another cell that is linked with the character A, then this cell is filled with 3 and linked with the label B. And so on.

For a cell for which the linking of a character is not immediately determinable it is useful to go through a Listing Step, where a List of all possible numbers for the cell can be made by deleting from consideration the numbers which conflict with a rule or with another cell already filled and linked with a character from the set A, B, C, . . . . Attempts can be made to place the numbers in the List one by one, similarly to the usual trial-and-error approach.

Since only one number can be correctly placed in a cell by assumption, eventually all the numbers in the List, except one, will lead to a contradiction. In such a case, one way to determine the character to link with this cell can be as follows: If the List is drawn when the only other cells are linked with characters B or A (or the ones given at the start) might be “in the play” for the determination of the character for the target empty cell, then pick a number from the List and tentatively link it to C and proceed to fill other cells. If the contradiction thereupon occurs at the stage of label E, for example, make a record of this fact, then attempt to place the next number in the List. Suppose the next number on the List also ends in a contradiction, at the stage of linking the character F, again make a record of this fact. Proceed similarly with all numbers in the List. Suppose L ends up being the “highest” label (that is, with the highest ordinal in the sequence of labels) for numbers in the List for which there is contradiction. Then link M with this cell.

For record keeping and organizing this algorithm, it is useful to introduce a different set of characters that can be mapped to the set of linking characters A, B, C etc., and associate them with the List. One such set of characters can be the lower case Roman letters, a, b, c, etc., to be used as follows: if when the List of possible numbers for a particular cell is drawn, no other cell with the label higher than A is in the play, associate the character “a” with the List; if no other cell with the label higher than B is of concern then associate the character “b” with the List; and so on; and, if the List is drawn on the basis of the pre-filled cells only then do not associate any lower case character with the List.

Since the lower case letters a, b, c, etc. have a natural mapping to upper case letters A, B, C, . . . , it is useful to use them as a secondary set associated with the Lists of possible numbers for the empty cells; they capture the state (the “snapshot”) of the puzzle solution-in-progress at the end of the linking of the upper case characters A, B, C, etc. with the cells, whereas the linking of the letters A, B, C etc. can be thought of being carried out at the beginning of the relevant stage (A or B or C etc.) of filling in the cells.

The Figures provide examples of this algorithm, showing the linked character labels A, B, C etc. next to the number placed in the cell to the right of the number, and the characters a, b, c, etc. to the left of the List, shown elsewhere within the cell.

The explanations below relate to these figures as concrete examples. FIGS. 1 and 3 are the Sudoku puzzles appearing in The Big Book of Sudoku, published by Parragon in the 2009 edition, as No. 3 and No. 289, respectively. FIGS. 2 and 4 respectively, present solutions for the puzzles shown in FIGS. 1 and 3.

The puzzle “No. 3” of FIG. 1 shows 36 cells filled already at the start, leaving 45 empty cells for a player to fill. By the rules of Sudoku the 45 empty cells must be filled with one, and only one, number from 1 to 9 in such a way that no cell can be left blank at the end, and no number may occupy more than one cell in a row or a column or in a 3 by 3 block, delineated by the solid lines, within which the empty cell being filled lies.

A solution of the puzzle is shown in FIG. 2 displaying the labels according to the algorithm of the disclosure herein. For this easy problem the displayed solution needed to use the labels A, B and C only. For example, the cell in row 1, column 6, i.e., cell no. (1,6), is shown filled with number 9 with label A, since all other numbers 1 to 8 will conflict with at least one other already filled cell, or conflict with a rule. Here, cell no. (1,6) could be tentatively be filled with other numbers; but placing 9 in another empty cell in the box will be inconsistent with the rule that a number cannot be repeated in a row or a column; this is because all other empty cells in the 3 by 3 block have a 9 in the corresponding row or column—therefore number 9 cannot be placed in any other empty cell in the block.

The number 4 in cell (4,8) carries the label A for a slightly different reason: all numbers other than 4 will conflict with a cells filled at the start. Thus, 1 in (4,8) conflicts with 1 in (7,8), repetition in the same column; 2 conflicts with (6,6), repetition in the same box and with (4,6), repetition in the same row; 3 conflicts with (4,2), repetition in the same row; 5 with (4,3), repetition in the same row; 6 with (6,8), repetition in the same box and in the same column, and with (4,1) repetition in the same row; 7 with (6,9), repetition in the same box; 8 with (5,8), repetition in the same box; and 9 with (4,9), repetition in the same box and the same row.

The number 8 in (4,5) carries the label B since the numbers 1-7 and 9 conflict with the cells (5,6), (2,5) and (4,7) for 1; (4,6), (3,5) for 2; (4,2) for 3; (4,8) for 4; (4,3) for 5; (5,4) and (4,1) for 6; (8, 5) and (4,4) for 7; and, (6,4) and (4,9) for 9. Some of these cells are linked with label A. In particular, the number 4 conflicts only with the cell no. (4,8), labeled with A, and all other numbers conflict with a pre-filled cells carrying no higher label. But because the number 4 can only be excluded because of one cell labeled A, the 8 in (4,5) is labeled B.

The cell (6,6) is filled with the number 3 and is labeled C because the cells (5,5) for 4 and (7,6) for 5, both with label B will conflict with (6,6), and also, no cell with label A or lower can eliminate the numbers 4 and 5 from consideration.

It is desirable in this scheme, in order to demonstrate conflict, to pick conflicting cells with “lowest” possible label to link with a cell where “lower” means one that appears earlier in the alphabet.

Additionally, if the objective is to find the most efficient solution, the numbers may be associated with the labels in an increasing order, and the efficiency of the sequence defined so that the lower the weighted average the more efficient the solution.

It is possible in this scheme also to introduce other selection criteria for the conflicting cells. For example, it may be stipulated that a cell in the same box as the cell being filled will be picked over a cell in the same row or column if the conflicting cells carry the same label.

The puzzle of FIG. 1 has 45 empty cells. The labels for the solution in FIG. 2 are: 16 A's, 18 B's and 11 C's. For quantification of the solution, using the number 1 for A, 2 for B and 3 for C, the weighted average for this solution sequence is 1.888 . . . , which may be used as the “measure of efficiency” for this solution. Since this is a low number, the corresponding solution (sequence of filling the cells) may be regarded as “efficient.”

It takes more cogitation to optimize the measure of efficiency. Whereas the label A has been used for a conflicting cell in this solution, the label B might be used by a less careful player if he fails to recognize the option of choosing the sequence or the rule-based argument assuring a lower label. Consequently, the measure of efficiency (weighted average) for the less careful player will be higher. For instance, if while filling the cell (6,6) of the puzzle of FIG. 1, the player overlooks that 5 in cell (6,6) will conflict with a 5 in cell (7,6) and the label B, and determines that conflict will be with the 5 in cell (6,5) that carries the label C, then he may place the label D in cell (6,6), thereby increasing the weighted average.

This error by the less careful player may be viewed as arriving at the placement of the number 5 in the cell through a different sequence of steps and, unsurprisingly, a different weighted average and a different level of efficiency of the solution.

The method can be used for the puzzle in FIG. 3, No. 289, with a much longer sequence of steps. The number of empty cells at the start is 49. The solution given in FIG. 4 has the following distribution of labels: 6 A's, 6 B's, 4 C's, 1 D, 1 E, 2 F's, 7 G's, 7 H's, 9 I's and 5 J's, which shows that the correct number determination for several cells is much slower, reflected in an approximate weighted average of 5.8163.

Compared to the puzzle of FIG. 1, this puzzle is more difficult, with 49 spaces to fill rather than 45. The measure of efficiency, however, gives a much more precise comparison of difficulty levels of the two puzzles, approximately 5.8 versus 1.8 for the puzzle of FIG. 1. Clearly the difference is the result not only of the 4 additional empty spaces in this puzzle, but also the distribution of, and the numbers in the pre-filled cells, and it is reflected in a 10 labels, from A to J, as opposed to a 3 characters from A to C.

For other puzzles, alternative instructions for the maintaining the sequences of steps, formulas for allocating values for the steps or labels, and algorithms for computing the measurable quantities for efficiency may be employed. However, the goal with the alternatives still is to compute a measure of the efficiency of the solution based at least in part on the number and order of steps taken in a path towards the solution.

A partial solution to a puzzle called “Numbrix” is shown in FIG. 7. The cells are filled numbers between 1 and 81 in numerical order but in a horizontal or vertical path. The figure shows some of the cells with the labels A, B, C, etc. depending on stage at which the number was determined.

The cell in 6th row, 2nd column is filled with 81 but has the label M for the following reason: The 80-D in (7,2) position means that 81 can either go into (7,3) or (6,2). A trial of 81 in (7,3) however leads to an inconsistency, given that 56 is in (8,3) and 63 in (1,3). The two (all available) paths between (8,3) and (1,3) end in inconsistency at L starting from 57-E in (8,4). Therefore, 81 goes into cell (6,2) with the label M.

For this simple puzzle, there are not too many alternative paths, and it can be used for simple competitions.

Furthermore, such a scoring method for this and other simple puzzles can be useful in quantified psychological testing to benchmark or to measure the progress or regression of a player's mental faculties. Indeed, the methods of this disclosure for such simple puzzles provide the equivalent of a “mice in a maze” which has traditionally been the mainstay of psychological experiments.

For a crossword puzzle, where the cells need to be filled with letters in order to satisfy the given clues, for example, it may be more meaningful to employ the following set of instructions and formulas in order to discriminate between two paths to solution: (1) Start with a letter in a cell; (2) fill the cells in the box containing this cell to form the word or phrase according to the clue; (3) continue to fill the cells to form words or phrases according to the clues in the boxes where at least one cell has already been filled, but not the cells in boxes that do not have any letter filled in; (4) identify each of the cells filled in by the letter α; (5) fill a cell in a new “empty” box that has no cell filled with a letter; (6) starting the next sequence with this cell, continue to fill the cells to form words or phrases according to the clues in the boxes where at least one cell has already been filled, but not the cells in boxes that do not have any letter filled in; (7) identify each of the cells filled in by the letter β; (8) continue to fill the cells in the crossword puzzle in analogous, recursively manner until all boxes and cells are filled; (9) count the numbers of the cells that carry the identifiers α, β, γ, . . . ; (10) allocate numerical values to each of the letters α, β, γ, . . . ; (11) calculate the numerical measure of the solution by a formula based on the values allocated to the letters α, β, γ, . . . .

FIG. 8 shows a partial solution to a crossword puzzle, along with a few of the cells identified with the labels α and β. This solution starts with R in first cell for clue box number 34 across, and fills E and B to complete the box, with all three of these cells identified with α. Next, cells in the box for clue 3 are filled and identified with α, since the letter R is already filled in the box. The solution supposes that the puzzle solver hit an “impasse in the α chain,” and had to restart with clue box 21 that did not have any letter in it either across or down, filling them with the letters F, R, O, down and E, D, across, each of the corresponding cells therefore carry the identifier β.

The figure shows the partial solution where the process had to be started five times so far at boxes numbered 34, 21, 31, 54 and 25. Although no other identifiers are shown for legibility, the identifiers used are at least α, β, γ, δ, ε.

Several reasonable options exist for computing the numerical measure of the sequence of steps in this solution, the simplest being a weighted sum, viz., adding for each identifier the product of the number of cells with the identifier and the value associated with the identifier.

By using different colors for different labels this difference may be visually presented for instant communication of the difference in complexity of the two puzzles.

It will be recognized that there are many alternatives for defining the sequence of steps in a crossword puzzle as well, such that the order of completion is germane to scoring. And, finally any of several mathematical alternatives may be used for scoring formulas.

By using different colors, or by other distinct representations for the different labels, this difference may be visually presented for instant communication of the difference in complexity of the two puzzles. The measure of efficiency may be used to compare not only the solutions for the same puzzle, but also to compare, to an approximate extent, the solutions and inherent difficulty levels of two different puzzles.

FIG. 9 visually depicts the partial structure of the solution of FIG. 2 where the letters A, B and C correspond to different graphic patterns. For legibility this depiction shows only the squiggly graphic filling cells with labels C, but other cells can similarly be filled with colors, patterns or animation graphics to form a collage that reveals the structure of the puzzle.

It is important to note that the structure of a puzzle is only partially captured by the number of empty cells. The structure of Sudoku puzzle depends to a great extent on the distribution of the numbers provided in the cells at the start and such graphic depiction of the puzzle can provide much more information about the structure of the puzzle.

Non-visual hints may be provided based on the methods disclosed herein. As stated above, the hints may be auditory sounds, animation, or video. The hints may also comprise other types of input, for example, olfactory input, or combination of different types of input.

The hints must be able to be organized in a sequence and able to be associated with the discreet steps of the activity. Such organization would allow for hints that still do not reveal too much of the solution to detract from the pleasure of working out the puzzle but help a player was stuck at a particular point in the activity.

Additionally, similar to the color coding of visual hints, the auditory sound or other types of hints can be determined a priori and communicated to a player either dynamically when he clicks on a particular cell at any point in the process of solving the puzzle, or at the start.

As discussed above, for the case of typical Sudoku, the method may proceed, for example, as follows: (1) maintaining record of the order in which the cells are filled by digits 1-9, by linking the stage at which each cell is filled with the letters A, B, C etc. to represent the stages and the order of filling the empty cells; (2) associating numerical values with each of the letters A, B, C etc. (3) finding a weighted average for the solution, as executed in the exact order of filling the cells, which is the measure of the specific path taken to solution from the numbers of cells that carry each of the labels A, B, C etc. and their associated numerical values; (4) comparing two or more solutions (paths) by their respective measures, and (5) ranking the solutions in order according to their respective measures.

The labels A, B, C etc. used to obtain the rankings may further provide a segmentation of the puzzle board or activity. The segmentation can then be used to creatively express the solutions or the steps of the activity and combined into novel pieces of art, music and expressions in other media.

A segmentation of an activity or puzzle so obtained and expressed provides yet another method of segmentation in addition to the methods and mathematical tools, such as fractals and wavelets. When combined with the solution activity, this type of segmentation provides a unique experience, different from the utility of fractals and wavelet decompositions.

Segmentation obtained by the methods of this disclosure is particularly useful in creating replications of the expression, particularly for the display and enjoyment of multitudes of consumers.

Additional applications of the method in accordance with some embodiments of the invention are discussed below.

### Artistic Expression

The labels A, B, C, etc. may divide the a visual screen, game board or painting canvas into segments. A simple example is provided in FIG. 9 which shows a partial graphic depiction of the solution of puzzle of FIG. 1. In this case all cells which have the label C have been covered with a pattern of squiggly lines. If other cells labeled with A and B are similarly covered by other graphic patterns then a kind of collage will emerge which may visually provide much information about the puzzle, its structure and complexity, which can be useful to compare puzzles.

The visual expression can also be useful in rapid coding and decoding of data in cryptography.

The graphic representation when combined with artistic use of color can generate pictures that can provide an aesthetic experience.

In conjunction with musical differentiation, this graphic representation of a puzzle can further add to the enjoyment and experience of the solution activity.

Musical differentiation can also be harnessed by a creative composer to use the extra dimensions of the puzzle structure revealed by the methods disclosed herein to compose a musical piece that captures the essence of a puzzle. Unique compositions can also be created in an analogous manner for logic games and activities.

The visual expression of a puzzle can be interpreted in movement. And, both music and visual interpretation can be combined into dance. The values of stage decoration and management can further be combined into a presentation in front of a live or remote audience.

Several other possibilities are available to use a combination of audio, video, static art, management of stage architecture (including lighting) to create an engaging representation of a puzzle, which is artistic yet rooted in accessible logic.

All these values come together in the production of live or television shows.

### A Show on Television.

A few of the ways in which a show based on a puzzle or logic game for television are described below for illustrative purposes. Other variations are contemplated and envisioned.

A competition may be structured with the following roles: A moderator and at least two competitor-teams. Competition between two teams, described here may be extended analogously for more teams or players.

Both teams are given the same Sudoku puzzle to solve, though the method may be varied in an obvious manner to include the case where the problems are different and the winner is decided on the basis of the measure of efficiency achieved by the teams/players for their respective puzzles.

The teams may also be given equal or substantially equivalent time to solve their puzzles, or time utilization by the teams may be compared by a preset formula. Winner may then be decided based at least on the basis of a combination of scores for (1) time utilized, (2) solution obtained, (3) efficiency of the solution obtained, wherein efficiency of the solution is defined according to a method of the present invention.

A live audience in this scenario may see the progress of the solution activity on a divided stage, for instance, such that the activity of each team may be hidden from the other team, or the two teams may perform the solution activity at different time intervals while still occluding the activity of one team from that of the other team. The viewers at home or other remote viewers may watch the activity of both teams in succession or simultaneously on a split screen.

Each player is given the puzzle on one of the following: paper, computer, tablet, screen connected to internet, etc. Also given to each player is a device/means of communication with a system which can capture the solution activity for the audience, such as, an overhead projector screen. Solution session may be taped in the presence of live audience.

On this device the player may show the step of filling each cell as it is filled with a character, as well as the lists of candidate characters for any cell that the player chooses to use. The set of characters used to list candidate characters may actually be distinct from the set of characters used to fill the spaces, but as stated in the detailed description, appropriately related in order to allow determination and communication of correspondence between the two distinct sets.

A puzzle of the class under consideration requires that is a space may be filled with a character in the list of candidates unless there is a contradiction, i.e., the placement of the character is inconsistent with a rule, or with a character already in another cell.

For a show it is necessary to communicate this, mostly mental activity of decision making for the audience. The methods of this disclosure make it possible to do through the device of the labels.

For example, in order to communicate his reasons why other characters cannot occupy the cell when a player fills a space with a character he could do so by clicking or pointing to each cell filled in with a character that would contradict the placing of the other characters on the list of candidates and/or the rule that will be contradicted, and capturing that logic succinctly in the assigning of the label to the cell.

The correct assignment of the label is key (since the major of efficiency of the solution depends on it): list of potential characters that can be placed in a cell is of secondary importance—its importance derives from the fact that it may figure in the assignment of the final label.

Each team may be given time to recheck their work, importantly the assignment of labels: or the team may designate one player to check the work in progress.

There may or may not be any audience participation. For example, there may be no need for audience participation to resolve questions of logical import, and “logic judges or experts” may resolve such questions as the validity of characters, labels, lists of potentials and sequencing.

For other components of the judging audience may be invited to participate, whether in attendance or remotely. Thus the artistic merit of the interpretation of the complexity of the puzzle, for example, is a candidate for both—the input of experts may be combined into a weighted score by any of the formulas currently in vogue for several popular shows.

### Educational Activity

The presentation of the logical reasoning of a solution outlined above for television production can be profitably employed in face-to-face classes or in distance education. This may be an effective way to introduce elements of logic, argument and proof into a classroom.

Creation of New Games, Activities and Puzzles from Known Activities

The segmentation of a puzzle or activity by the disclosed methods can lend itself to further, systematic, creative approach to putting together of the activities. Overlays of puzzles of similar complexity may be created; a hint may be provided in one modality and may ask the player to judge its validity, then communicate it in another; an entire solution may be provided for a player as a challenge to improve its efficiency; several players may remotely solve a puzzle working either competitively or collaboratively, with time constraints and other appropriate constraints to minimize cheating.

The many examples provided in the foregoing disclosure are meant to be illustrative only, and not exhaustive. Practitioners of the related arts will recognize that many other extensions of labeling and scoring schemes, rules and instructions to complete the games and activities, and the variations of the puzzles, games and activities are possible, contemplated and envisioned by the disclosure.

FIG. 5 illustrates an example of a process 500 for ranking sequences of steps used to perform an activity, in accordance with some embodiments. The activity may be any suitable activity that involves different steps which may be taken via multiple alternative paths, as embodiments of the invention are not limited to any specific activity. Thus, different paths may be taken for completing the activity.

Process 500 may start at any suitable time. For example, process 500 may start when an activity is being performed or has been performed. The activity may comprise an initial state defined as a start of the activity, a set of instructions to determine which step or steps may follow a step of the activity, and a final state defined as an end of the activity.

At block 502, data comprising one or more sequences of steps for performing an activity is received. The data may be received in any suitable manner. If the activity is being currently performed (e.g., a person or a computer is completing a puzzle, one or more players provide input to as they are playing a game on a computer or a board game, etc.), the data may be received as each different sequence of steps is performed. If the activity is completed, the data may comprise information on more than one sequence of steps taken during the performance of the activity.

In some embodiments, the data may be received from a location where the activity took place. The data may be communicated via a network, such as the Internet or in any other suitable manner. The data may also be collected at the location where the activity is performed.

The data may be received in any suitable format. For example, it may be written on or otherwise represented on a tangible media, stored in a computer file, etc.

At block 504, a measurable quantity for each of the sequences of steps may be computed using an algorithm. The algorithm may be predefined in advance. The measurable quantities may be computing in any suitable way. For example, in some embodiments, the measurable quantities may be computed using one or more processors of a computing device.

At block 506, the measurable quantities may be compared. The comparison may be performed in any suitable manner. For example, the comparison may be performed using any suitable computing device. Though, it should be appreciated that embodiments of the invention are not limited in this respect.

At block 508, an ordering of the measurable quantities may be defined based on the comparison performed at block 506. Next, at block 510, the sequences may be ranked by the ordering. At block 512, a result of the ranking may be output. The result of the ranking may be output in any suitable manner. For example, it may be presented on a suitable tangible medium, non-limiting examples of which include a printed publication, a user interface which may be presented on a suitable display (e.g., a display of a game device, TV set, etc.), a computing device, a mobile phone and any other suitable medium.

The result of the ranking may be communicated to a suitable location via a network such as the Internet or a wired or wireless local area, or in any other manner. The result may be communicated to a location where it is presented, which may also be a location where the ranking is utilized a number of way as described herein and in any other ways. For example, when the activity is a game or a puzzle played by more than one player, the ranking may be utilized to evaluate a logical approach of each of the players to playing the game or solving a puzzle. In some embodiments, a winner may be determined based on the ranking. The evaluation based on the ranking as generated in accordance with the described techniques may be used in conjunction with a time measurement or other criteria. In some embodiments, each of the two different paths taken by a player may be compared to determine which path results in a higher ranking.

Furthermore, as schematically shown in FIG. 5, process 500 may be performed continuously, as the activity is being performed. For example, at each point of the activity, the rankings may be recomputed, based on the paths within the activity taken to arrive to that point.

In some embodiments, at least some acts of the described method may be implemented as computer-readable instructions stored on one or more non-transitory computer-readable storage media. The computer-readable instructions, when executed by one or more processors, may cause a computing device to execute the acts of the method. FIG. 6 illustrates an exemplary computer system on which some embodiments of the invention may be employed.

An illustrative implementation of a computer system 600 that may be used in connection with any of the embodiments of the invention described herein is shown in FIG. 6. The computer system 600 may include one or more processors 610 and one or more computer-readable non-transitory storage media (e.g., memory 620 and one or more non-volatile storage media 630). The processor 610 may control writing data to and reading data from the memory 620 and the non-volatile storage device 630 in any suitable manner, as the aspects of the present invention described herein are not limited in this respect. To perform any of the functionality described herein, the processor 610 may execute one or more computer-executable instructions stored in one or more computer-readable storage media (e.g., the memory 620), which may serve as non-transitory computer-readable storage media storing instructions for execution by the processor 610.

The above-described embodiments of the present invention can be implemented in any of numerous ways. For example, some aspects of the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general-purpose hardware (e.g., one or more processors) that is programmed using microcode or software to perform the functions recited above.

In this respect, it should be appreciated that one implementation of the embodiments of the present invention comprises at least one non-transitory computer-readable storage medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A method of ranking in order of two or more sequences of steps for carrying out an activity, the activity comprising an initial state defined as a start of the activity, a set of instructions to determine which step or steps may follow a step of the activity, and a final state defined as an end of the activity, and
wherein said method of ranking comprises the following steps:
(a) computing a measurable quantity for each of said sequences of steps using a preset algorithm;
(b) comparing the measurable quantities computed for each of two or more sequences of steps to carry out the activity;
(c) defining an ordering of said measurable quantities;
(d) ranking said two or more sequences by the ordering of said measurable quantities; and
(e) presenting a result of said ranking on a tangible medium.

2. The method of claim 1, wherein said tangible medium is a printed publication.

3. The method of claim 1, wherein said tangible medium comprises a computing device.

4. The method of claim 1, wherein the result of said ranking is communicated via a computerized network.

5. The method of claim 1, wherein the result of said ranking is communicated via the Internet.

6. The method of claim 1, wherein said tangible medium is a television set.

7. The method of claim 1, wherein said activity comprises linking a character in a set of distinct characters to each empty space in a set of distinct spaces, and a set of rules for linking a character to a space,
wherein:
one or more of spaces in the set of spaces may have a character or characters linked at the start of the activity;
each of a set of specified spaces in the set of spaces has a character linked to it at end of the activity;
an Empty Space is a space in that does not have a character linked to it;
the set of spaces comprises at least one Empty Space;
a Step of the activity comprises linking a character from said set of characters to an empty space not inconsistent with any rule in said set of rules and not inconsistent with any linking of characters with spaces at the start of the activity;
a Causally Connected pair of steps as a pair of steps where a Consequent step follows a Causal step by execution of said set of rules;
a Connected Chain of steps as a sequence of causally connected pairs of steps, wherein the first step is a causal step, each succeeding step except the last step in the chain is a consequent step and a causal step, and the last step is a consequent step, and
a sequence of steps having at least one connected chain as a Path;
said measurable quantity is Measure of Efficiency of a path; and
said preset algorithm comprises the following steps:
(a) allocating a value to the linking of a character to a space for each step of the path according to a preset formula;
(b) finding Aggregate Value for the path by combining the values allocated to each step of the path according to a preset algorithm;
(c) computing Measure of Efficiency of said path based at least in part on said Aggregate Value.

8. The method of claim 7, wherein said preset algorithm is based at least in part on a weighted sum of the values allocated each step.

9. The method of claim 8, wherein Measure of Efficiency of the path equals the result of dividing Aggregate Value by the number of spaces in the said path which are linked to characters in the set of characters.

10. The method of claim 7, wherein said step of the activity comprises optionally defining for an empty space a subset of the set of characters to which a character belongs if not inconsistent with a rule and not inconsistent with a character linked to a space causally connected to the empty space.

11. The method of claim 10, wherein the allocating of value to said linking of character to empty space is by the following steps:
(a1) determining for each character in said subset all paths with the empty space as the causal step for which last step is inconsistent with a rule or inconsistent with a character linked to a space causally connected to the empty space or inconsistent with the linking of a character to a space in a connected chain in the path;
(a2) finding the number of consequent steps from the empty space for all paths with the empty space as the causal step for which last step is inconsistent with a rule or inconsistent with a character linked to a space causally connected to the empty space or inconsistent with the linking of a character to a space in a connected chain in the path;
(a3) finding an integer value based in part on the said numbers of consequent steps;
(a5) allocating a value to the linking of a character to the empty space based on said integer value.

12. The method of claim 11, wherein said integer value is at least equal to the maximum of the smallest number of consequent steps from the empty space for all paths from the empty space which end in inconsistency with a rule or inconsistency with a character linked to a space causally connected to the empty space.

13. The method of claim 1, wherein:
the set of distinct characters is {Char(1), Char(2), . . . , Char(I), . . . Char(λ)}, collectively identified as {CHARS};
the set of spaces is {Space(1), Space(2), . . . , Space(I), . . . Space(σ)}, collectively identified as {SPACES};
the set of rules is {Rule(1), Rule(2), . . . , Rule(I), . . . Rule(ρ)}, collectively identified as {RULES}; and,
the linking of a character Char(J) with a Space(K) for integers J and K, for 1≦J≦λ and 1≦K≦σ, includes associating Label(I) with the linking, wherein Label(I) is a member of a sequence of labels,
{ LABELS}={Label(1), Label(2), . . . , Label(I), . . . }, and
wherein,
(a) Label (1) is associated with a character, Char(J), linked to a space, Space(K), if the linking is not inconsistent with the linking of {CHARS} to {SPACES} at the start of the activity; and
(b) Label (I) is associated with a character Char(J), linked to a space Space(K), if the linking is not inconsistent with:
(i) a Rule in the set {RULES};
(ii) the linking of {CHARS} to {SPACES} at the start of the said activity; or
(iii) association of the labels Label(1), Label(2), . . . , Label(I−1) with the linking of characters in {CHARS} to spaces other than Space(K).

14. The method of claim, 13 wherein said step of the activity comprises optionally defining set Char_List, wherein Char_List is a subset of {CHARS}, and Char(J) for 1≦J≦λ belongs to Char_List if linking of Char(J) to Space(K) is not inconsistent with a rule and not inconsistent with a character linked to a space causally connected to Space(K).

15. The method of claim 1, further comprising:
(f) optionally receiving the ranking from an intangible medium;
(g) optionally communicating the ranking to the tangible medium.

16. The method of claim 1, wherein the activity comprises at least one of a game, a puzzle, and a learning activity.

17. The method of claim 16, further comprising:
receiving data comprising the sequences of steps.

18. The method of claim 1, wherein:
the sequences of steps comprise a first plurality of sequences, each sequence of the first plurality of sequences comprising a plurality of steps of performing the activity by one or more users; and
the method further comprises:
evaluating the performance of the activity by the one or more users based on the ranking.

19. The method of claim 18, further comprising:
identifying a winner based on the evaluating of the performance of the activity by the one or more users.

20. A method of generating a ranking in order of two or more sequences of steps for carrying out an activity, the activity comprising an initial state defined as a start of the activity, a set of instructions to determine which step or steps may follow a step of the activity, and a final state defined as an end of the activity, the method comprising:
computing, by at least one processor, a value associated with each of the sequences of steps using an algorithm;
comparing the values computed for each of two or more sequences of steps to carry out the activity;
defining an ordering of the values; and
generating the ranking of the two or more sequences by the ordering of the values; and
providing an output comprising the ranking.

21. The method of claim 20, further comprising:
communicating the ranking to a tangible medium.

22. The method of claim 21, further comprising:
presenting the ranking on the tangible medium.

23. The method of claim 21, further comprising:
wherein the tangible medium comprises a display.

24. The method of claim 15 wherein the intangible medium comprises encoding capability for acoustic signals.

25. The method of claim 24 wherein the intangible medium comprises capability to play acoustic signals.

26. The method of claim 25 wherein acoustic signals for one or more steps of the activity are combined into a composition.

27. The method of claim 25 wherein said acoustic signals comprise the testing of auditory discrimination of a test subject.

28. The method of claim 1 wherein said tangible medium is a display device capable of displaying ranking data from an external source.

29. The method of claim 28 wherein said external source is a human or an automaton.

30. The method of claim 29 wherein said human is one of many humans.

31. The method of claim 30 wherein said automaton may be remotely controlled.

32. The method of claim 23 wherein said display is projection on an overhead screen.

33. The method of claim 26 wherein said composition may be synchronized with the movements of a human or an automaton.

34. The method of claim 26 wherein said composition may be synchronized with an external display of lights.

35. The method of claim 23 wherein said display is a display of one or more paths by matching the steps of the paths with a numbered sequence of visual items.

36. The method of claim 34 wherein said display of lights is a dance floor.
